(19) United States
(12) Patent Application Publication
(10) Pub. No.: US 2011/0030447 A1
(43) Pub. Date: Feb. 10, 2011

(54) CRIMPING TOOL WITH PIVOTABLE WORKPIECE HOLDER

(76) Inventors: THOMAS EMERY BACKENSTOES, Harrisburg, PA (US); CHRISTOPHER JOHN GAVLAK, Mechanicsburg, PA (US)

Correspondence Address: Lisa Burgin Vaccarelli;Tyco Technology Resources, Suite 140, 4550 New Linden Hill Road, Wilmington, DE, 19808, US

(21) Appl. No.: 12/537,074

(22) Filed: Aug. 6, 2009

(51) Int. Cl. H01R 43/042; B25B 27/14

(52) U.S. Cl. 72/409.14; 29/751

(57) ABSTRACT

A crimping tool is provided for crimping a workpiece. The crimping tool includes a crimping head having a crimping zone and a crimping jaw held within the crimping zone. The crimping tool also includes a workpiece holder having a holding element configured to hold the workpiece. The workpiece holder is pivotally connected to the crimping head. The workpiece holder is pivotable between a loading position and a crimping position. The workpiece is receivable by the holding element when the workpiece holder is in the loading position. The holding element holds the workpiece in the crimping zone for engagement with the crimping jaw when the workpiece holder is in the crimping position. A cover plate is held by the workpiece holder. The cover plate is movable relative to the workpiece holder between an open position and a closed position. The cover plate is configured to engage the workpiece when the workpiece is held by the holding element of the workpiece holder.

### BACKGROUND OF THE INVENTION

The subject matter described and/or illustrated herein relates generally to crimping tools, and more particularly, to crimping tools having pivotable workpiece holders for holding one or more workpieces in a crimping zone of the crimping tool.

Crimping tools are widely used for crimping a wide variety of workpieces. For example, crimping tools are used to crimp electrical terminals onto electrical conductors. Crimping tools typically include a crimping head having an opening defining a crimping zone. A crimping jaw is held in the crimping zone for crimping the workpiece. The crimping jaw typically includes a stationary crimping element and a movable crimping element that is driven toward the stationary crimping element to crimp the workpiece therebetween. Workpieces are sometimes manually positioned in the crimping zone using a person's fingers to grasp and insert the workpiece into the crimping zone. However, when manually positioning the workpiece, it may be difficult to determine if the workpiece is properly positioned for crimping within the crimping zone. For example, when crimping a terminal to a conductor, the terminal and the conductor have to be brought to a certain relative position with respect to the crimping elements. It may be difficult to see whether the terminal and conductor are properly positioned relative to each other and the crimping elements when the terminal and/or the conductor are held manually by a user. Moreover, it may be difficult to manually position relatively small workpieces within the crimping zone while keeping the person's fingers away from the crimping elements.

Some known crimping tools include a workpiece holder for positioning and holding the workpiece within the crimping zone. For example, the workpiece holder may be pivotally connected to the crimping head between a loading position and a crimping position. In the loading position, the workpiece is loaded to the workpiece holder. The workpiece holder is then pivoted to the crimping position wherein the workpiece holder holds the workpiece in the crimping zone. However, at least some known workpiece holders may not securely hold the workpiece during crimping. For example, contact with the crimping elements may partially dislodge the workpiece from a the workpiece holder and/or may rotate the workpiece, which may cause the workpiece to be crimped in an unintended orientation and/or at an unintended location of the workpiece. Moreover, it may be difficult to see a holding element of the workpiece holder even when the workpiece holder is in the loading position, which may make it difficult to fully load the workpiece to the workpiece holder.

### BRIEF DESCRIPTION OF THE INVENTION

In one embodiment, a crimping tool is provided for crimping a workpiece. The crimping tool includes a crimping head having a crimping zone and a crimping jaw held within the crimping zone. The crimping tool also includes a workpiece holder having a holding element configured to hold the workpiece. The workpiece holder is pivotally connected to the crimping head. The workpiece holder is pivotable between a loading position and a crimping position. The workpiece is receivable by the holding element when the workpiece holder is in the loading position. The holding element holds the workpiece in the crimping zone for engagement with the crimping jaw when the workpiece holder is in the crimping position. A cover plate is held by the workpiece holder. The cover plate is movable relative to the workpiece holder between an open position and a closed position. The cover plate is configured to engage the workpiece when the workpiece is held by the holding element of the workpiece holder.

In another embodiment, a crimping tool is provided for crimping a workpiece. The crimping tool includes a crimping head having a crimping zone and a crimping jaw held within the crimping zone. The crimping head defines a crimping head plane. The crimping jaw is movable along a crimping axis that lies within and is parallel to the crimping head plane. The crimping tool also includes a workpiece holder having a holding element configured to hold the workpiece. The workpiece holder is pivotally connected to the crimping head about a pivot axis. The workpiece holder is pivotable about the pivot axis between a loading position and a crimping position. The workpiece is receivable by the holding element when the workpiece holder is in the loading position. The holding element holds the workpiece in the crimping zone for engagement with the crimping jaw when the workpiece holder is in the crimping position. The pivot axis of the workpiece holder is angled obliquely to the crimping head plane.

### BRIEF DESCRIPTION OF THE DRAWINGS

FIG. 1 is a perspective view of an exemplary embodiment of a crimping tool.

FIG. 2 is an elevational view of a side of the crimping tool shown in FIG. 1.

FIG. 3 is a perspective view of an exemplary embodiment of a crimping head of the crimping tool shown in FIGS. 1 and 2 illustrating the crimping head in a loading position.

FIG. 4 is a plan view of the crimping tool illustrating an exemplary embodiment of a pivot axis of a workpiece holder of the crimping tool shown in FIGS. 1 and 2.

FIG. 5 is a cross-sectional view of a portion of an exemplary embodiment of a workpiece holder of the crimping tool shown in FIGS. 1 and 2.

FIG. 6 is a perspective view of the crimping head shown in FIG. 3 illustrating the workpiece holder in a crimping position.

### DETAILED DESCRIPTION OF THE INVENTION

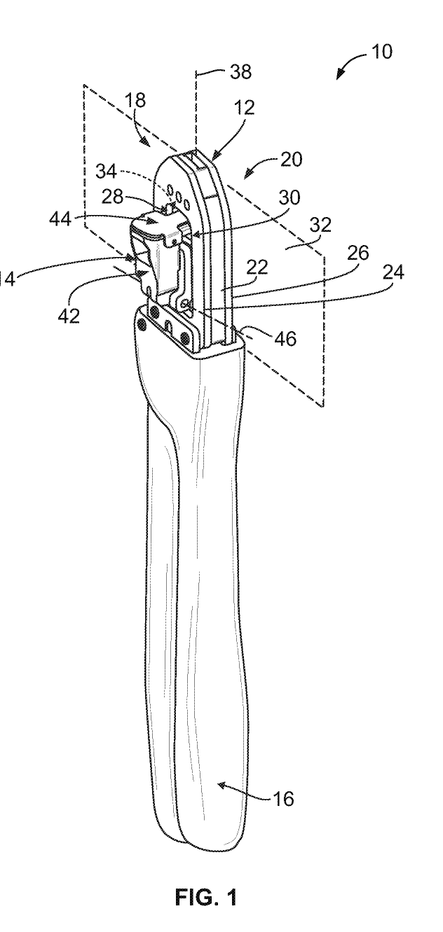

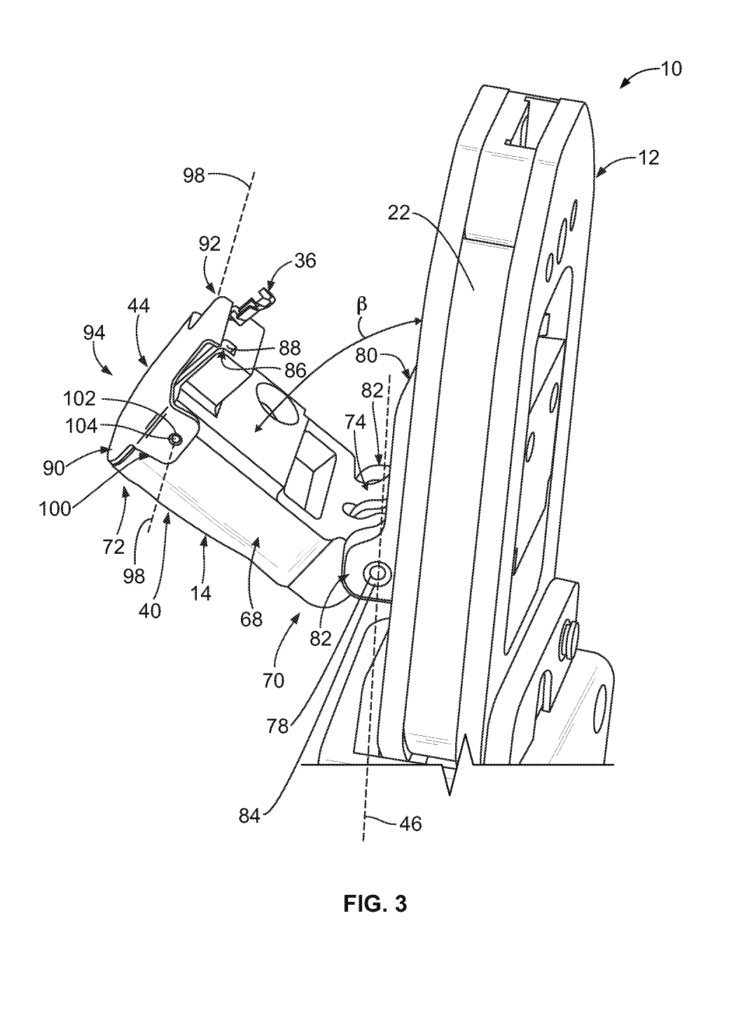

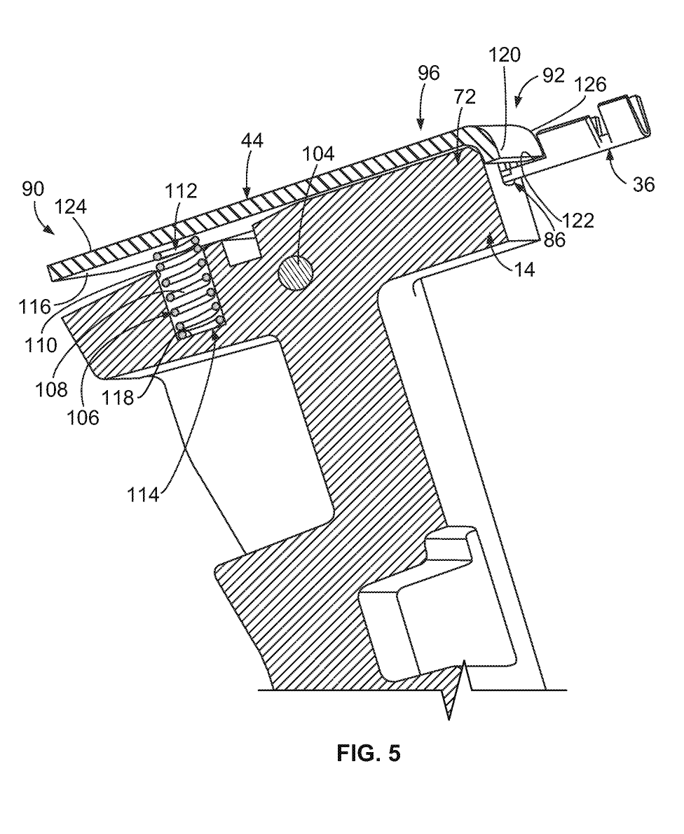

FIG. 1 is a perspective view of an exemplary embodiment of a crimping tool 10. The crimping tool 10 includes a crimping head 12, a workpiece holder 14, and an actuator 16. The crimping head 12 includes opposite sides 18 and 20. In the exemplary embodiment, the crimping head 12 includes a central plate 22 held between a pair of side plates 24 and 26. The side plate 24 includes the side 18 of the crimping head 12, while the side plate 26 includes the side 20 of the crimping head 12. An opening 28 extends through the crimping head 12. Specifically, the opening 28 extends through the side plate 24, the central plate 22, and the side plate 26. The opening 28 defines a crimping zone 30 and the crimping head 12 defines a crimping head plane 32. A crimping jaw 34 is held by the crimping head 12 within the crimping zone 30 for crimping one or more workpieces 36 (FIGS. 3 and 5). The crimping jaw 34 is movable along a crimping axis 38 that lies within and is parallel to the crimping head plane 32. The workpiece holder 14 holds and positions the workpiece 36 within the crimping zone 30. The workpiece holder 14 is pivotally connected to the crimping head 12 on the side 18 of the crimping head 12. The workpiece holder 14 is pivotable relative to the crimping head 12 between a loading position 40 (FIG. 3) and a crimping position 42. To crimp the workpiece 36, the workpiece 36 is loaded into the workpiece holder 14 when the workpiece holder 14 is in the loading position 40. The workpiece holder 14 is then pivoted to the crimping position 42, wherein the workpiece holder holds and positions the workpiece 36 in a predetermined position and/or orientation relative to the crimping jaw 34. The actuator 16 drives the crimping jaw 34 to close the crimping jaw 34 into engagement with the workpiece 36 and thereby crimp the workpiece 36 therebetween.

As will be described below, a cover plate 44 is held by the workpiece holder 14 for engaging the workpiece 36. The cover plate 44 facilitates holding the workpiece 36 in a predetermined orientation and position relative to the crimping jaw 34 during crimping of the workpiece 36. As will also be described below, a pivot axis 46 of the workpiece holder 14 is angled obliquely to the crimping head plane 32.

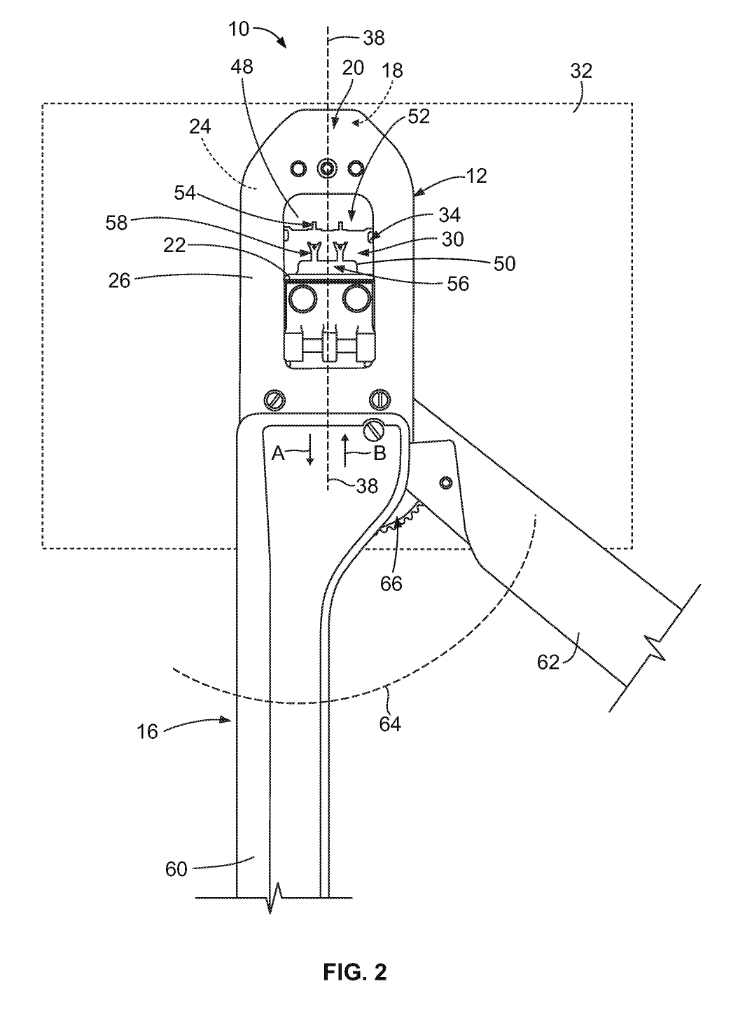

FIG. 2 is an elevational view of the crimping tool 10 illustrating the side 20 of the crimping tool 10 that is opposite the side 18 on which the workpiece holder 14 is connected. In the exemplary embodiment, the crimping jaw 34 includes a stationary crimping element 48 and a movable crimping element 50. Alternatively, the crimping jaw 34 includes two or more movable crimping elements 50. The stationary crimping element 48 remains stationary relative to the crimping head 12 during crimping of the workpiece 36 (FIGS. 3 and 5). In the exemplary embodiment, the stationary crimping element 48 is an integral extension of the central plate 22. Alternatively, the stationary crimping element 48 is a separate component that is held by the central plate 22, the side plate 24, the side plate 26, and/or any other component of the crimping head 12. The stationary crimping element 48 extends within the crimping head plane 32 and into the crimping zone 30 to a pressing end 52. The pressing end 52 engages the workpiece 36 during crimping of the workpiece 36. The pressing end 52 optionally includes one or more dies 54 that have a complementary size and/or shape relative to a size and/or shape of the workpiece 36 before crimping and/or relative to a predetermined crimped size and/or shape of the workpiece 36. In the exemplary embodiment, the pressing end 52 includes two dies 54 for crimping two workpieces 36. However, the pressing end 52 may include any number of dies 54 for crimping any number of workpieces 36.

The movable crimping element 50 of the crimping jaw 34 is held by the crimping head 12 such that the movable crimping element 50 is movable along the crimping axis 38 within the crimping head plane 32. In the exemplary embodiment, the movable crimping element 50 is held within a channel (not shown) of the central plate 22. However, the movable crimping element 50 may additionally or alternatively be held by the central plate 22, the side plate 24, the side plate 26, and/or any other component of the crimping head 12 that enables the movable crimping element 50 to move along the crimping axis 38 within the crimping head plane 32. The movable crimping element 50 extends within the crimping head plane 32 and into the crimping zone 30 to a pressing end 56. The pressing end 56 of the movable crimping element 50 engages the workpiece 36 during crimping of the workpiece 36. The pressing end 56 optionally includes one or more dies 58 that have a complementary size and/or shape relative to a size and/or shape of the workpiece 36 before crimping and/or relative to a predetermined crimped size and/or shape of the workpiece 36. Although two dies 58 are shown, the pressing end 56 of the movable crimping element 50 may include any number of dies 58 for crimping any number of workpieces 36.

The movable crimping element 50 is operatively connected to the actuator 16 for moving the movable crimping element 50 along the crimping axis 38. In the exemplary embodiment, the actuator 16 includes a pair of levers 60 and 62. The levers 60 and 62 are moved relative to each other to move the movable crimping element 50 along the crimping axis 38. Specifically, the levers 60 and 62 are movable relative to each other along an arc 64. In the exemplary embodiment, the lever 60 is stationary relative to the crimping head 12, while the lever 62 is movable relative to the crimping head 12 along the arc 64. In addition or alternative to the lever 62, the lever 60 is optionally movable along the arc 64 relative to the crimping head 12. The levers 60 and 62 are opened relative to each other along the arc 64 to move the movable crimping element 50 along the crimping axis 38 away from the stationary crimping element 48, which is indicated in FIG. 2 by the arrow A. The levers 60 and 62 are closed relative to each other along the arc 64 to move the movable crimping element 50 along the crimping axis 38 in a direction toward the stationary crimping element 48, which is indicated in FIG. 2 by the arrow B.

In the exemplary embodiment, the movable crimping element 50 is operatively connected to the lever 62 via one or more links (not shown) that translate the movement of the levers 60 and/or 62 along the arc 64 to the linear movement of the movable crimping element 50 along the crimping axis 38. The links optionally include a ratcheting mechanism 66, which may include a release mechanism (not shown). In addition or alternative to the links, the movable crimping element 50 may be operatively connected to the levers 60 and 62 using any other structure, means, arrangement, configuration, and/or the like that enables the levers 60 and 62 to move the movable crimping element 50 along the crimping axis 38.

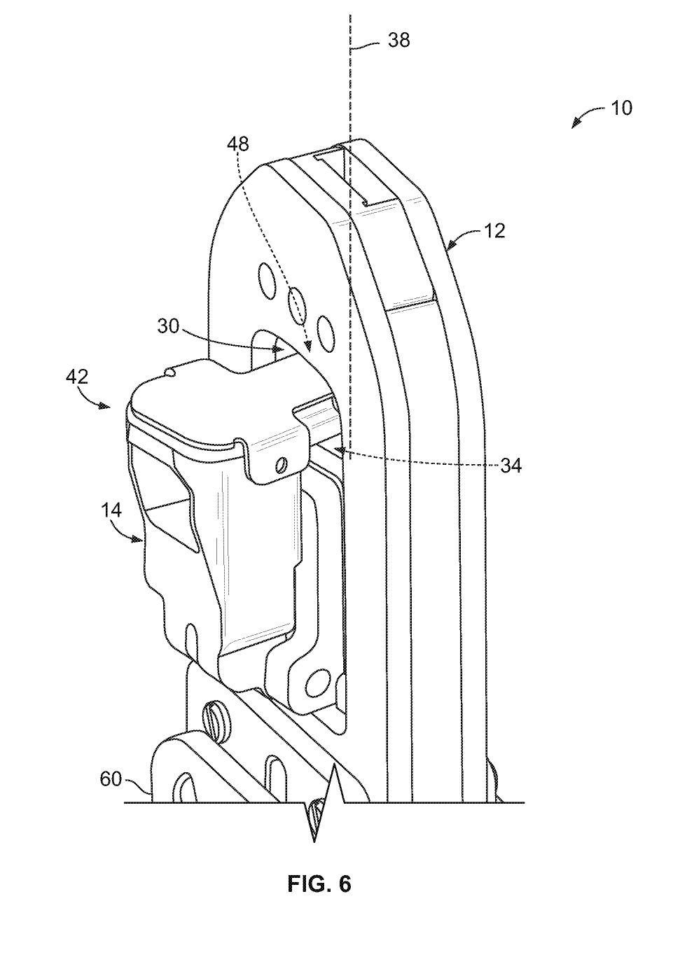

FIG. 3 is a perspective view of an exemplary embodiment of the crimping head 12 of the crimping tool 10 illustrating the crimping head 12 in the loading position 40. The workpiece holder 14 includes a body 68 extending from a pivot end 70 to a workpiece end 72. The pivot end 70 of the workpiece holder 14 is pivotally connected to the crimping head 12 such that the workpiece end 70 is pivotable between the loading position 40 and the crimping position 42 (FIGS. 1 and 6). In the exemplary embodiment, the pivot end 70 of the body 68 includes one or more flanges 74 that include holes (not shown) for receiving a pivot bearing 78. A pivot plate 80 is mounted on the central plate 22 of the crimping head 12. The pivot plate 80 may be mounted on the central plate 22 and/or any other component of crimping head 12 using any structure, means, arrangement, configuration, and/or the like, such as, but not limited to, adhesive, threaded fasteners, other types of fasteners besides threaded fasteners, and/or the like. The pivot plate 80 also includes one or more flanges 82 that include holes 84 for receiving the pivot bearing 78. The holes of the workpiece flanges 74 are aligned with the holes 84 of the pivot plate flanges 82. The pivot bearing 78 is received through the holes of the workpiece flanges 76 and the holes 84 of the pivot plate flanges 82 to hold the pivot end 70 of the workpiece holder 14 on the pivot plate 80.

The pivot bearing 78 extends a length along the pivot axis 46, which is a central longitudinal axis of the pivot bearing 78. In the exemplary embodiment, the pivot bearing 78 is a solid rod that is sized and shaped relative to the holes of the workpiece flanges 76 and the holes 84 such that the workpiece holder 14 can rotate, or pivot, about the pivot bearing 78 relative to the crimping head 12. In addition or alternative to the pivot bearing 78, the flanges 74 and/or 82, the holes of the flange 74, and/or the holes 84, the workpiece holder 14 may be pivotally mounted on the pivot plate 80 using any other structure, means, arrangement, configuration, type of bearing, and/or the like. For example, the workpiece holder 14 may be pivotally mounted on the pivot plate 80 using a flexural bearing, a roller bearing, a ball bearing, and/or the like.

The workpiece end 72 of the body 68 includes one or more holding elements 86 that are configured to hold the workpiece 36. In the exemplary embodiment, the body 68 includes two holding elements 86 for holding two workpieces 36. However, the body 68 may include any number of the holding elements 86, which each may hold any number of workpieces 36. The holding elements 86 are shown herein as receptacles 88 that receive a portion of the corresponding workpiece 36 therein. Each holding element 86 optionally includes a complementary size and/or shape relative to a size and/or shape of a portion of the corresponding workpiece 36. An exemplary workpiece 36 is shown in FIGS. 3 and 5 as received within one of the receptacles 88. The exemplary workpiece 36 is an electrical terminal that is to be crimped to an electrical conductor (not shown). However, the workpiece 36 may be any other type of workpiece having any other structure (e.g., size, shape, and/or material) that is desired to be crimped besides an electrical terminal. Moreover, in some embodiments, one or more of the holding elements 86 is configured to hold a different type of workpiece 36 than one or more of the other holding elements 86. Although shown as receptacles 88, each holding element 86 may additionally or alternatively include a projection (not shown) that is received within a portion of the corresponding workpiece 36.

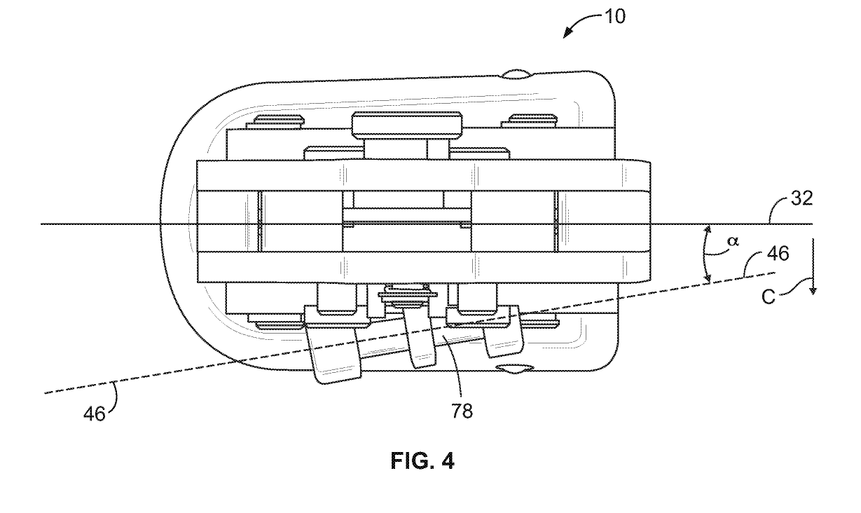

FIG. 4 is a plan view of the crimping tool 10 illustrating an exemplary embodiment of the pivot axis 46 of the workpiece holder 14 (FIGS. 1, 3, 5, and 6). The workpiece holder 14 has been removed from FIG. 4 for clarity. As described above, the pivot axis 46 about which the workpiece holder 14 pivots is angled a obliquely to the crimping head plane 32. The pivot axis 46 may be angled at any oblique angle a with respect to the crimping head plane 32. In the exemplary embodiment, the pivot axis 46 is angled approximately 8° with respect to the crimping head plane 32. In some embodiments, the pivot axis 46 is angled between approximately 1° and approximately 89° with respect to the crimping head plane 32. Moreover, in some embodiments, the pivot axis 46 is angled between approximately 5° and approximately 15° with respect to the crimping head plane 32. Further, in some embodiments, the pivot axis 46 is angled between approximately 6° and approximately 10° with respect to the crimping head plane 32. As can be seen in FIG. 4, the pivot bearing 78 is spaced apart from the crimping head plane 32 in the direction of the arrow C. Alternatively, the pivot bearing 78 intersects the crimping head plane 32.

FIG. 5 is a cross-sectional view of a portion of an exemplary embodiment of the workpiece holder 14 illustrating the cover plate 44. Referring now to FIGS. 3 and 5, the cover plate 44 is held on the workpiece end 72 of the workpiece holder 14. The cover plate 44 extends a length from an actuation end 90 to an engagement end 92. The cover plate 44 is movable relative to the workpiece holder 14 between an open position 94, shown in FIG. 3, to a closed position 96, shown in FIG. 5. In the exemplary embodiment, the cover plate 44 is pivotally connected to the workpiece end 72 of the workpiece holder 14 about a pivot axis 98. The cover plate 44 is pivotable about the pivot axis 98 between the open position 94 and the closed position 96.

In the exemplary embodiment, the cover plate 44 includes one or more flanges 100 (not visible in FIG. 5) that include holes 102 (not visible in FIG. 5) for receiving a pivot bearing 104. The pivot bearing 104 is received through the holes of the flanges 100 to hold the cover plate 44 on the workpiece end 72 of the workpiece holder 14. The pivot bearing 104 is thus operatively connected between the cover plate 44 and the workpiece holder 14. The pivot bearing 104 extends a length along the pivot axis 98, which is a central longitudinal axis of the pivot bearing 104. In the exemplary embodiment, the pivot bearing 104 is a solid rod that is sized and shaped relative to the holes 102 such that the cover plate can rotate, or pivot, about the pivot bearing 104 relative to the workpiece holder 14. In addition or alternative to the pivot bearing 104, the flanges 100, and/or the holes 102, the cover plate 44 may be pivotally mounted on the workpiece holder 14 using any other structure, means, arrangement, configuration, type of bearing, and/or the like. For example, the cover plate 44 may be pivotally mounted on the workpiece holder 14 using a flexural bearing, a roller bearing, a ball bearing, and/or the like.

Referring now to FIG. 5, the cover plate 44 is optionally biased to the closed position 96. Specifically, in the exemplary embodiment, a biasing mechanism 106 is operatively connected between the cover plate 44 and the workpiece holder 14 to bias the cover plate 44 to the closed position 96. In the exemplary embodiment, the biasing mechanism 106 is a coil spring 108 that is received within a recess 110 within the workpiece end 72 of the workpiece holder 14. The coil spring 108 extends from an end 112 to an opposite end 114. The end 112 of the coil spring 108 is engaged with a surface 116 of the actuation end 90 of the cover plate 44, while the end 114 of the coil spring 108 is engaged with a bottom 118 of the recess 110 within the workpiece holder 14. The coil spring 108 applies a biasing force to the surface 116 of the actuation end 90 of the cover plate 44, which causes the cover plate 44 to pivot about the pivot axis 98 (FIG. 3) toward the closed position 96. The cover plate 44 is thereby spring-loaded toward the closed position 96.

In addition or alternative to the coil spring 108, the biasing mechanism 106 may include any other type of biasing mechanism, such as, but not limited to, another type of spring (such as, but not limited to, a leaf spring and/or the like) and/or the like. Moreover, the biasing mechanism 106 may be operatively connected between the workpiece holder 14 and the cover plate 44 in any other configuration, arrangement, and/or the like in addition or alternative to the arrangement and configuration shown herein.

In the closed position 96 shown in FIG. 5, the engagement end 92 of the cover plate 44 is engaged with the workpiece 36. In the exemplary embodiment, the engagement end 92 of the cover plate 44 includes one or more lips 120 that engage the workpiece 36. The lip 120 is optionally received within an opening 122 within the workpiece 36. When engaged with the workpiece 36, the engagement end 92 of the cover plate 44 facilitates holding the workpiece 36 in a predetermined orientation and position relative to the crimping jaw 34 (FIGS. 1 and 2). For example, engagement between the engagement end 92 of the cover plate 44 and the workpiece 36 may facilitate preventing the workpiece 36 from rotating and/or partially dislodging from the corresponding holding element 86 during crimping of the workpiece 36. Moreover, and for example, engagement between the cover plate 44 and the workpiece 36 may facilitate retaining the workpiece 36 within the holding element 86, and in the predetermined orientation and position, when the workpiece holder 14 is in the loading position. Further, and for example, engagement between the cover plate 44 and the workpiece 36 may facilitate retaining the workpiece 36 within the holding element 86, and in the predetermined orientation and position, as the workpiece holder 14 is pivoted toward the crimping position 42.

The engagement end 92 of the cover plate 44 is movable between the open position 94 and the closed position 96. By pressing on a surface 124 of the actuation end 90 of the cover plate 44 that is opposite the surface 116 engaged by the coil spring 108, the cover plate 44 can be pivoted about the pivot axis 98, against the bias of the biasing mechanism 106, from the closed position 96 to the open position 94. Referring again to FIG. 3, in the open position 94, the engagement end 92 of the cover plate 44 is withdrawn from the holding elements 86 such that each holding element 86 is exposed and available to receive the corresponding workpiece 36.

To crimp a workpiece 36, the workpiece holder 14 is pivoted to the loading position 40 shown in FIG. 3. Although shown as an acute angle β, the workpiece holder 14 may be angled at any angle β of between approximately 1° and approximately 180° relative to the crimping head 12. The workpiece holder 14 and/or the crimping head 12 optionally include a stop (not shown) to locate the workpiece holder 14 at a predetermined angle β relative to the crimping head 12 in the loading position 40. Once in the loading position 40, the workpiece 36 can be received by the holding elements 86. The workpiece holder 14 is then pivoted about the pivot axis 46 to the crimping position 42.

FIG. 6 is a perspective view of the crimping head 12 illustrating the workpiece holder 14 in the crimping position 42. In the crimping position, the workpiece 36 (FIGS. 3 and 5) is held by the workpiece holder 14 within the crimping zone 30 in a predetermined position and/or orientation relative to the crimping jaw 34. The levers 60 and 62 (FIG. 2) are then closed relative to each other to move the movable crimping element 50 (FIG. 2) along the crimping axis 38 in toward the stationary crimping element 48. As the movable crimping element 50 is moved toward the stationary crimping element 48, the respective pressing ends 56 and 52 (FIG. 2) engage the workpiece 36 to crimp the workpiece 36 therebetween.

The workpiece holder 14 and the crimping head 12 optionally include any type of latch (not shown) for latching the workpiece holder 14 in the crimping position 42. For example, the latch may be a magnetic latch, may include a hook that is received within an opening, and/or the like. Other examples of the latch include, but are not limited to, an interference fit between the workpiece holder 14 and the crimping head 12, a snap-fit between the workpiece holder 14 and the crimping head 12, and/or the like.

The embodiments described and/or illustrated herein provide a workpiece holder for a crimping tool that is less likely to allow a workpiece to rotate and/or partially dislodge from the workpiece holder during crimping of the workpiece. The embodiments described and/or illustrated herein may provide a workpiece holder that is easier to load with the workpiece than at least some known workpiece holders. For example, the embodiments described and/or illustrated herein may provide a workpiece holder having a holding element that is more easily seen when the workpiece holder is in a loading position.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Similarly, the terms “front”, “rear”, “top”, “bottom”, and “side” etc. in the claims are used merely as labels, and are not intended to impose orientational requirements on their objects. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the description and illustrations. The scope of the subject matter described and/or illustrated herein should therefore be determined with reference to the appended claims, along with the full scope of equivalents to which such claims are entitled. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

What is claimed is:

1. A crimping tool for crimping a workpiece, said crimping tool comprising:
a crimping head comprising a crimping zone and a crimping jaw held within the crimping zone;
a workpiece holder comprising a holding element configured to hold the workpiece, the workpiece holder being pivotally connected to the crimping head, the workpiece holder being pivotable between a loading position and a crimping position, the workpiece being receivable by the holding element when the workpiece holder is in the loading position, the holding element holding the workpiece in the crimping zone for engagement with the crimping jaw when the workpiece holder is in the crimping position; and
a cover plate held by the workpiece holder, the cover plate being movable relative to the workpiece holder between an open position and a closed position, the cover plate being configured to engage the workpiece when the workpiece is held by the holding element of the workpiece holder.

2. The crimping tool according to claim 1, further comprising a biasing mechanism operatively connected between the cover plate and the workpiece holder, the biasing mechanism biasing the cover plate to the closed position.

3. The crimping tool according to claim 1, wherein the cover plate is pivotally connected to the workpiece holder about a pivot axis, the cover plate being pivotable about the pivot axis between the open and closed positions.

4. The crimping tool according to claim 1, further comprising a pivot bearing operatively connected between the cover plate and the workpiece holder, the cover plate being pivotable about the pivot bearing between the open and closed positions.

5. The crimping tool according to claim 1, wherein the cover plate comprises a lip that is configured to engage the workpiece when the workpiece is held by the holding element of the workpiece holder and the cover plate is in the closed position.

6. The crimping tool according to claim 1, wherein the cover plate extends a length from an actuation end to an engagement end, wherein actuation of the actuation end moves the engagement end from the closed position to the open position.

7. The crimping tool according to claim 1, wherein the cover plate comprises a lip that is configured to be received within an opening of the workpiece when the workpiece is held by the holding element of the workpiece holder and the cover plate is in the closed position.

8. The crimping tool according to claim 1, wherein the crimping jaw comprises a stationary crimping element and a movable crimping element.

9. The crimping tool according to claim 1, wherein engagement between the cover plate and the workpiece at least one of:
retains the workpiece at least one of within and on the holding element; and
holds the workpiece in a predetermined orientation relative to the workpiece holder.

10. The crimping tool according to claim 1, wherein the holding element of the workpiece holder comprises at least one of a receptacle and a projection.

11. A crimping tool for crimping a workpiece, said crimping tool comprising:
a crimping head comprising a crimping zone and a crimping jaw held within the crimping zone, the crimping head defining a crimping head plane, the crimping jaw being movable along a crimping axis that lies within and is parallel to the crimping head plane; and
a workpiece holder comprising a holding element configured to hold the workpiece, the workpiece holder being pivotally connected to the crimping head about a pivot axis, the workpiece holder being pivotable about the pivot axis between a loading position and a crimping position, the workpiece being receivable by the holding element when the workpiece holder is in the loading position, the holding element holding the workpiece in the crimping zone for engagement with the crimping jaw when the workpiece holder is in the crimping position, wherein the pivot axis of the workpiece holder is angled obliquely to the crimping head plane.

12. The crimping tool according to claim 11, wherein the pivot axis of the workpiece holder is angled between approximately 5° and approximately 15° with respect to the crimping head plane of the crimping head.

13. The crimping tool according to claim 11, wherein the pivot axis of the workpiece holder is angled between approximately 6° and approximately 10° with respect to the crimping head plane of the crimping head.

14. The crimping tool according to claim 11, further comprising a pivot bearing operatively connected between the workpiece holder and the crimping head, the workpiece holder being pivotable about the pivot bearing between the loading and crimping positions.

15. The crimping tool according to claim 11, further comprising a pivot bearing operatively connected between the workpiece holder and the crimping head, the pivot bearing being spaced apart from the crimping head plane of the crimping head.

16. The crimping tool according to claim 11, further comprising a pivot bearing operatively connected between the workpiece holder and the crimping head, the pivot bearing intersecting the crimping head plane of the crimping head.

17. The crimping tool according to claim 11, wherein at least one of the workpiece holder and the crimping head comprises a magnet for latching the workpiece holder in the crimping position.

18. The crimping tool according to claim 11, wherein the crimping jaw comprises a stationary crimping element and a movable crimping element, the movable crimping element being movable along the crimping axis.

19. The crimping tool according to claim 11, wherein the crimping zone comprises an opening extending within the crimping head, the crimping jaw being held within the opening.

20. The crimping tool according to claim 11, wherein the holding element of the workpiece holder comprises at least one of a receptacle and a projection.
